(19) United States
(12) Patent Application Publication
(10) Pub. No.: US 2025/0011168 A1
(43) Pub. Date: Jan. 9, 2025

(54) METHOD FOR PRODUCING BLUE HYDROGEN

(71) Applicant: LOTTE CHEMICAL CORPORATION, Seoul (KR)

(72) Inventors: Hanseul Choi, Daejeon (KR); Eo Jin Lee, Daejeon (KR); Myung-gi Seo, Daejeon (KR)

(73) Assignee: LOTTE CHEMICAL CORPORATION, Seoul (KR)

(21) Appl. No.: 18/713,348

(22) PCT Filed: Nov. 22, 2022
(86) PCT No.: PCT/KR2022/018519

§ 371 Date: May 24, 2024

(30) Foreign Application Priority Data
Nov. 25, 2021 (KR) 10-2021-0164911

(51) Int. Cl. C01B 3/48; C01B 3/12; C01B 3/56; C01D 7/07; C01D 7/10

(52) U.S. Cl. CPC C01B 3/48; C01B 3/12; C01B 3/56; C01D 7/07; C01D 7/10; C01B 2203/0205; C01B 2203/0283; C01B 2203/043; C01B 2203/1241

(57) ABSTRACT

The present invention pertains to a method for producing blue hydrogen, the method including the steps of: obtaining a mixed gas containing hydrogen and carbon dioxide by performing a water gas shift (WGS) process with a product obtained through a steam methane reforming (SMR) process using natural gas and steam; preparing an aqueous sodium carbonate solution or an aqueous sodium hydroxide solution in a dissolving tank; performing a bicarbonate reaction by introducing the mixed gas into a carbonation reactor together with the aqueous sodium carbonate solution or the aqueous sodium hydroxide solution; obtaining high-purity hydrogen gas from the carbonation reactor; and obtaining sodium bicarbonate from downstream of the carbonation reactor.

### TECHNICAL FIELD

The present invention relates to a method for producing blue hydrogen.

### BACKGROUND ART

Most hydrogen produced today is produced through a steam methane extraction method, which extracts hydrogen through a catalytic reaction between methane and water at high temperature. However, during the production, excessive amounts of carbon dioxide are generated and, when there is no separate treatment process, are released into the atmosphere. Currently, to produce hydrogen from natural gas, desulfurization (DeS) reaction, steam methane reforming (SMR) reaction, water-gas shift (WGS) reaction, preferential oxidation (PROX) reaction, and the like are required sequentially.

Hydrogen may be classified into gray hydrogen, blue hydrogen, and green hydrogen depending on the production method and degree of eco-friendliness. Most of the hydrogen currently produced is produced from fossil fuels, and is gray hydrogen, which emits about 10 kg of carbon dioxide into the atmosphere in the process of producing about 1 kg of hydrogen. In the case of blue hydrogen, carbon dioxide generated during the production process is captured or stored rather than released into the atmosphere, and the amount of carbon dioxide released into the atmosphere is significantly reduced compared to gray hydrogen. Furthermore, green hydrogen is hydrogen produced through the process of producing hydrogen and oxygen by adding electrical energy obtained through renewable energy to water, and produces no carbon dioxide released during the hydrogen production process.

Currently, as global demands related to carbon dioxide reduction increase, research on conversion from gray hydrogen to green hydrogen is actively underway. In the process of conversion from gray hydrogen to green hydrogen, blue hydrogen, which dramatically reduces the amount of carbon dioxide released into the atmosphere, is attracting attention as a realistic alternative.

Currently, for the production of blue hydrogen, not only has the technology to separately capture carbon dioxide generated as a by-product at an on-site hydrogen station not yet been prepared, but even when captured, there is also the issue that it is not easy to prepare space to store carbon dioxide. Accordingly, research is needed on effective ways to avoid emitting carbon dioxide into the atmosphere from hydrogen production.

### PRIOR ARTS

### Patent Document

(Patent Document 1) Korean Patent Application Publication No. 10-2021-0086015

### DISCLOSURE

### Technical Problem

The present invention is directed to providing a method for producing blue hydrogen. Specifically, the present invention is directed to providing an integrated system capable of significantly reducing the amount of carbon dioxide released into the atmosphere and producing not only hydrogen but also sodium bicarbonate by utilizing carbon dioxide generated in the process of producing hydrogen from natural gas as a raw material for sodium bicarbonate.

### Technical Solution

One aspect of the present invention provides a method for producing blue hydrogen, the method including: obtaining a mixed gas containing hydrogen and carbon dioxide by performing a water gas shift (WGS) process with a product obtained through a steam methane reforming (SMR) process using natural gas and steam; preparing an aqueous sodium carbonate solution or an aqueous sodium hydroxide solution in a dissolving tank; performing a bicarbonate reaction by introducing the mixed gas into a carbonation reactor together with the aqueous sodium carbonate solution or the aqueous sodium hydroxide solution; obtaining high-purity hydrogen gas from the carbonation reactor; and obtaining sodium bicarbonate from a downstream of the carbonation reactor.

### Advantageous Effects

When a method for producing blue hydrogen according to the present invention is applied, the amount of carbon dioxide emitted when hydrogen is produced from natural gas can be dramatically reduced, and furthermore, there is a benefit in obtaining additional high-purity sodium bicarbonate.

### DESCRIPTION OF DRAWINGS

FIG. 1 shows a process schematic diagram of a conventional SMR process.

FIG. 2 shows a schematic diagram of a conventional carbonation process.

FIG. 3 shows a schematic diagram of the production process of blue hydrogen according to an embodiment of the present invention.

### MODES OF THE INVENTION

In this specification, when a certain portion “comprises or includes” a certain component, this indicates that the other components are not excluded and may be further included unless specially described otherwise.

Hereinafter, the present invention will be described in detail.

An embodiment of the present invention provides a method for producing blue hydrogen, the method including: obtaining a mixed gas containing hydrogen and carbon dioxide by performing a water gas shift (WGS) process with a product obtained through a steam methane reforming (SMR) process using a natural gas and steam; preparing an aqueous sodium carbonate solution or an aqueous sodium hydroxide solution in a dissolving tank; performing a bicarbonate reaction by introducing the mixed gas into a carbonation reactor together with the aqueous sodium carbonate solution or the aqueous sodium hydroxide solution; obtaining high-purity hydrogen gas from the carbonation reactor; and obtaining sodium bicarbonate downstream of the carbonation reactor.

According to an embodiment of the present invention, the obtaining of the mixed gas containing hydrogen and carbon dioxide may be obtained by sequentially performing the SMR process and the WGS process known in the art.

According to an embodiment of the present invention, the high-purity hydrogen gas may be obtained by treating upstream from the carbonation reactor with at least one process selected from a pressure swing adsorption (PSA) process, a thermal swing adsorption (TSA) process, or a membrane separation method. Specifically, the high-purity hydrogen gas may be obtained by treating the upstream from the carbonation reactor through the PSA process. However, it is not limited thereto, and hydrogen purification methods known in the art may be applied. In addition, the specific details of the PSA process, the TSA process, and the membrane separation method which are known in the art may be appropriately applied depending on the purpose.

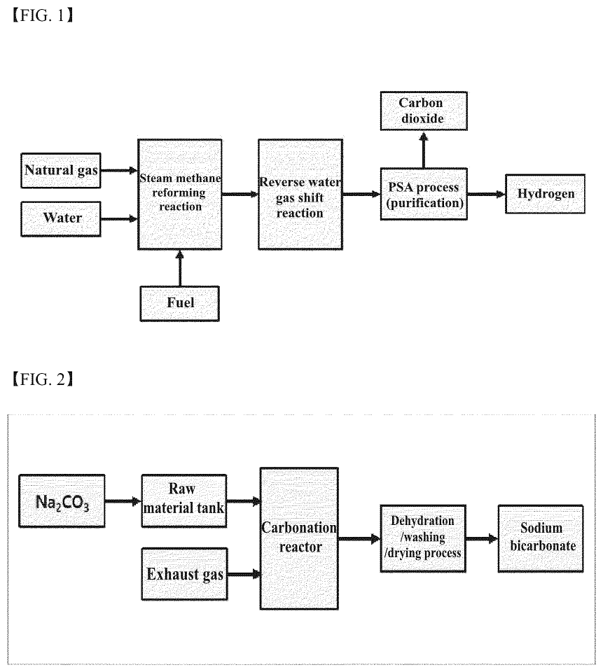

FIG. 1 shows a process schematic diagram of a conventional SMR process. Specifically, FIG. 1 shows a schematic diagram of a process for obtaining hydrogen from natural gas by applying the conventional SMR process and WGS process. When hydrogen is produced using natural gas as shown in FIG. 1, a huge amount of carbon dioxide is emitted into the atmosphere. In contrast, an embodiment of the present invention introduced carbon dioxide emitted as such into the carbonation process for producing sodium bicarbonate, thereby greatly reducing carbon dioxide emissions into the atmosphere and developing a process that may simultaneously obtain hydrogen and sodium bicarbonate.

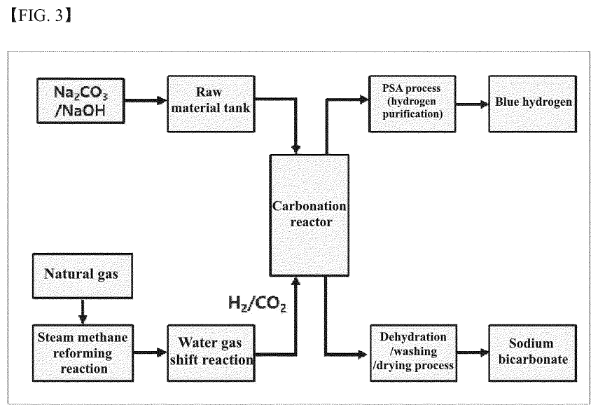

FIG. 2 shows a schematic diagram of a conventional carbonation process. Specifically, FIG. 2 shows a process for producing sodium bicarbonate by preparing sodium carbonate (or sodium hydroxide) into an aqueous solution in a raw material tank and then introducing the same into the carbonation reactor along with exhaust gas containing carbon dioxide.

FIG. 3 shows a schematic diagram of the production process of blue hydrogen according to an embodiment of the present invention. According to FIG. 3, using natural gas as a raw material, the SMR process and the WGS process are sequentially performed to obtain a mixed gas containing hydrogen and carbon dioxide, which is introduced into the carbonation reactor, and sodium carbonate or sodium bicarbonate is prepared as an aqueous solution in a raw material tank (dissolving tank) and introduced into the carbonation reactor to perform a bicarbonation reaction. The upstream produced from the reaction in the carbonation reactor contains hydrogen gas, and the hydrogen gas is purified through the PSA process to obtain blue hydrogen. Furthermore, the downstream produced from the reaction of the carbonation reactor may include sodium bicarbonate slurry, and sodium bicarbonate may be obtained through dehydration, washing, and drying processes. When the method for producing blue hydrogen according to the present invention is applied, most of the carbon dioxide generated when hydrogen is generated from natural gas may be converted into sodium bicarbonate, and the amount of carbon dioxide released into the atmosphere may be controlled to be almost nothing. In other words, because the process according to the present invention does not emit most of the carbon dioxide generated when hydrogen is produced from natural gas into the atmosphere, the hydrogen produced according to the present invention may be classified as blue hydrogen.

According to an embodiment of the present invention, in the carbonation reactor, only carbon dioxide in the mixed gas selectively reacts, and hydrogen in the mixed gas may escape through the upstream without participating in the reaction.

According to an embodiment of the present invention, the carbonation reactor may use the pressure in the SMR process without separate pressure increase. Specifically, the carbonation reactor may be performed under a pressure atmosphere of 1 bar to 40 bar, 5 bar to 40 bar, 10 bar to 40 bar, 5 bar to 30 bar, 10 bar to 30 bar, or 10 bar to 20 bar. The pressure in the SMR process, which is performed under a pressure of 10 bar to 40 bar without separate pressure increase, may be used. As such, when pressure is used in the SMR process, the solubility of carbon dioxide in the carbonation reactor increases, and the efficiency of the carbonation reaction may be greatly improved compared to when performed at normal pressure.

According to an embodiment of the present invention, the dissolving tank may be used to prepare an aqueous sodium carbonate solution or an aqueous sodium hydroxide solution at an appropriate concentration. Specifically, the dissolving tank may be used to prepare an aqueous sodium carbonate solution.

According to an embodiment of the present invention, the concentration of the aqueous sodium carbonate solution or the aqueous sodium hydroxide solution may be controlled to be 10 wt % or more and less than 30 wt %. Specifically, the concentration of the aqueous sodium carbonate solution or the aqueous sodium hydroxide solution may be controlled to be 15 wt % or more and 25 wt % or less. When the concentration of the aqueous sodium carbonate solution or aqueous sodium hydroxide solution introduced into the carbonation reactor exceeds the above range, hydrates may be generated and the yield of sodium bicarbonate may be reduced. In addition, when the concentration of the aqueous sodium carbonate solution or aqueous sodium hydroxide solution introduced into the carbonation reactor does not reach within the above range, the production efficiency of sodium bicarbonate may decrease, resulting in the inability to effectively remove carbon dioxide in the mixed gas.

According to an embodiment of the present invention, the temperature in the carbonation reactor may be controlled to be 30° C. or more and 50° C. or less. The temperature in the carbonation reactor may be controlled to be 35° C. or more 50° C. or less, or 40° C. or more 50° C. or less. When the temperature in the carbonation reactor is adjusted within the above range, the conversion to sodium bicarbonate may be maximized by optimizing the carbonation reaction and the solubility of carbon dioxide.

According to an embodiment of the present invention, the pH in the carbonation reactor may be 9 or more. When the pH in the carbonation reactor is less than 9, the production amount of sodium bicarbonate is reduced, and thus the removal rate of carbon dioxide in the mixed gas may also be reduced.

According to an embodiment of the present invention, there may be further included dehydrating the downstream from the carbonation reactor, separating the same into powder and filtrate, and recycling the filtrate to the dissolving tank. When these additional stages are applied, unreacted sodium carbonate or sodium hydroxide from the carbonation reaction may be effectively recycled, thereby increasing the yield of sodium bicarbonate.

According to an embodiment of the present invention, the amount of carbon dioxide released into the atmosphere among the carbon dioxide produced from the natural gas may be less than 10%. Specifically, the amount of carbon dioxide released into the atmosphere among the carbon dioxide produced from the natural gas may be less than 5%, less than 3%, less than 2%, less than 1%, or 0%. Specifically, in the method for producing blue hydrogen according to the present invention, the efficiency in the carbonation reactor is further increased, and the adsorption efficiency of unreacted carbon dioxide in the carbonation reactor is increased through the PSA process, so that the amount of carbon dioxide released into the atmosphere may be reduced to zero.

As described above, the method for producing blue hydrogen according to the present invention utilizes the generated carbon dioxide as a raw material for sodium bicarbonate, a high-value-added material, instead of capturing and storing carbon dioxide generated in the conventional method for producing gray hydrogen, and thus there is a benefit of being able to operate with a minimal carbon dioxide storage space by minimizing the amount of carbon dioxide captured.

Hereinafter, the present invention will be described in detail with reference to examples. However, the examples according to the present invention may be modified into various other forms, and the scope of the present invention should not be construed as being limited to the examples described below. The examples of this specification are provided to more completely explain the present invention to those skilled in the art.

### EXAMPLE 1

In order to identify whether carbon dioxide was reduced in the method for producing blue hydrogen according to the present invention, an experiment was conducted using a simulated gas mixed with carbon dioxide and air. Since hydrogen does not directly participate in the bicarbonation reaction, there was no difficulty in identifying the reduction of carbon dioxide even when the above simulated gas was used. In addition, when the SMR process and the WGS process were preceded, the bicarbonation reaction could be performed in a high-pressure atmosphere using the pressure thereof, but for convenience, the bicarbonation reaction was carried out under a pressure of 1 bar. Specifically, the simulated gas and the aqueous sodium carbonate solution whose concentration was adjusted to 15 wt % in the dissolving tank were introduced into the carbonation reactor. The flow rate of the simulated gas was controlled to about 18 m³/h, and the bicarbonation reaction was performed under a temperature of about 45° C. while controlling a pH to be maintained to be 9 or higher. After performing the bicarbonation reaction, the downstream from the carbonation reactor was subjected to dehydration, washing, and drying to obtain sodium bicarbonate.

### EXAMPLE 2

Sodium bicarbonate was obtained in the same manner as in Example 1, except that the aqueous sodium carbonate solution in the dissolving tank was adjusted to a concentration of 25 wt %.

### REFERENCE EXAMPLE

Sodium bicarbonate was obtained in the same manner as in Example 1, except that the aqueous sodium carbonate solution in the dissolving tank was adjusted to a concentration of 25 wt %. In this connection, hydrates were generated in the carbonation reactor, causing the pipe to become blocked, making it difficult to obtain sodium bicarbonate smoothly.

The purity, conversion of sodium bicarbonate, and production speed of sodium bicarbonate prepared according to Examples 1 and 2 and Reference Example were shown in Table 1 below.

According to the results in Table 1, it was identified that when the concentration of the aqueous sodium carbonate solution introduced into the carbonation reactor was 30 wt % or more, the pipe was blocked due to the generation of hydrates, making it difficult to smoothly produce sodium bicarbonate. Furthermore, it was identified that as the concentration of the aqueous sodium carbonate solution decreased, the production speed of sodium bicarbonate and the conversion of sodium carbonate decreased, lowering economic feasibility. Accordingly, it was identified that the optimal concentration of aqueous sodium carbonate solution considering economic efficiency was about 25 wt %. Furthermore, referring to the results in Table 1, when hydrogen is produced as in the present invention, the amount of carbon dioxide released into the atmosphere during the process of producing hydrogen from natural gas may be greatly reduced, and high-purity sodium bicarbonate may also be obtained.

1. A method for producing blue hydrogen, the method comprising:
obtaining a mixed gas containing hydrogen and carbon dioxide by performing a water gas shift process with a product obtained through a steam methane reforming process using natural gas and steam;
preparing an aqueous sodium carbonate solution or an aqueous sodium hydroxide solution in a dissolving tank;
performing a bicarbonate reaction by introducing the mixed gas into a carbonation reactor together with the aqueous sodium carbonate solution or the aqueous sodium hydroxide solution;
obtaining high-purity hydrogen gas from an upstream of the carbonation reactor; and
obtaining sodium bicarbonate from a downstream of the carbonation reactor.

2. The method of claim 1, wherein the high-purity hydrogen gas is obtained by treating the upstream from the carbonation reactor with at least one process selected from a pressure swing adsorption process, a thermal swing adsorption process, or a membrane separation method.

3. The method of claim 1, wherein the carbonation reactor uses a pressure in the steam methane reforming process without a separate pressure increase.

4. The method of claim 1, wherein a concentration of the aqueous sodium carbonate solution or the aqueous sodium hydroxide solution in the dissolving tank is controlled to be 10 wt % or more and less than 30 wt %.

5. The method of claim 1, further comprising dehydrating the downstream from the carbonation reactor, separating the same into powder and filtrate, and recycling the filtrate to the dissolving tank.

6. The method of claim 1, wherein an amount of carbon dioxide released into the atmosphere among the carbon dioxide produced from the natural gas is less than 10%.
